(19) United States
(12) Patent Application Publication
(10) Pub. No.: US 2026/0132929 A1
(43) Pub. Date: May 14, 2026

(54) COOKTOP LOCKOUT

(71) Applicant: WHIRLPOOL CORPORATION, Benton Harbor, MI (US)

(72) Inventors: Kasun S. Lankananda, St. Joseph, MI (US); Luciano Furuti, Stevensville, MI (US); Reid Albrecht, Kalamazoo, MI (US); Thomas E. Holwerda, Coloma, MI (US)

(21) Appl. No.: 18/943,058

(22) Filed: Nov. 11, 2024

(51) Int. Cl. F24C 7/08; H05B 1/02

(52) U.S. Cl. CPC F24C 7/085; F24C 7/088; H05B 1/0266

(57) ABSTRACT

Switches such as knobs are configured to control power to heating elements of a cooktop. Measurement points of a cooktop circuit are utilized to confirm that the switches of the cooktop are off. Responsive to selection of a lock control of a cooktop while not in a cooktop lockout mode, the measurement points are utilized to confirm that switches of the cooktop are off. Responsive to confirming that the power is not being supplied, a control board relay drive signal is applied to open normally closed relays to enter the cooktop lockout mode. Responsive to selection of the lock control while in the cooktop lockout mode, the measurement points are used to confirm for unlocking that the switches are off. Responsive to the confirmation for unlocking indicating that the switches are off, the control board relay drive signal is removed to close the relays and exit the cooktop lockout mode.

### TECHNICAL FIELD

Aspects of the disclosure generally relate to a cooktop lockout feature and cooktop fault detections that are implemented through use of normally closed (NC) relays.

### BACKGROUND

A cooktop lockout may allow users to disable the controls of the cooktop. This provides the user a peace of mind by preventing the cooktop from being accidentally turned on. When the lockout is engaged, the cooktop's controls become inactive, ensuring the appliance cooktop cannot be used until the lockout is deactivated.

A relay is an electrically operated switch used to control a circuit by a separate low-power signal or multiple circuits with one signal. Relays are commonly used in various applications, including automotive, industrial, and home automation systems. The terms normally open (NO) and normally closed (NC) describe the default state of the relay contacts when the relay coil is not energized. When a NO relay is not energized (no current flows through the coil), the contacts are open, meaning there is no connection between the common (COM) terminal and the normally open (NO) terminal. When a NC relay is not energized the contacts are closed, meaning there is a connection between the common (COM) terminal and the normally closed (NC) terminal.

### SUMMARY

Switches, such as knobs, are configured to control power to heating elements of a cooktop. Measurement points of a cooktop circuit are utilized to confirm that the switches of the cooktop are off. Responsive to selection of a lock control of a cooktop while not in a cooktop lockout mode, the measurement points are utilized to confirm that switches of the cooktop are in the off position. Responsive to confirming that the switches are off, a control board relay drive signal is applied for opening the normally closed relays to enter the cooktop lockout mode. Responsive to selection of the lock control again while the cooktop is in the cooktop lockout mode, the measurement points are used to confirm for unlocking that the switches are off. Responsive to the confirmation for unlocking indicating that the switches are off, the control board relay drive signal is removed to close the relays and exit the cooktop lockout mode.

In one or more illustrative examples, a circuit for controlling a cooktop lockout feature includes a first switch connected to main power and configured to control the main power to a first heating element of a cooktop; a first normally closed relay configured to receive a control board relay drive signal to selectively connect a switched power line to the first switch; one or more measurement points configured to measure power along the circuit; a lock control; and a controller. The controller is configured to, responsive to selection of the lock control while not in a cooktop lockout mode, utilize the one or more measurement points to confirm that at least the first switch is in an OFF position where power is not being supplied to the first heating element, and responsive to confirmation that the power is not being supplied, apply the control board relay drive signal to open the first normally closed relay to enter the cooktop lockout mode.

In one or more illustrative examples, the one or more measurement points include a PILOT input measurement point after the first switch connected to a pilot light, and a RELAY input measurement point along the switched power line between the first normally closed relay and the first switch, and the controller is configured to ensure before energizing the first normally closed relay that there is no power at the PILOT input measurement point to confirm the OFF position of the first switch and that there is power at the RELAY input measurement point. The controller is further configured to, responsive to detection of power at the PILOT input measurement point, indicate in a human-machine interface (HMI) of the cooktop that the cooktop lockout mode cannot be entered because the first switch is ON. The controller is further configured to, responsive to failure to detect power at the RELAY input measurement point, indicate an error code for the cooktop.

In one or more illustrative examples, the controller is further configured to, after energizing the first normally closed relay, if the main power is detected at the RELAY input measurement point, indicate an error code that the cooktop has an issue with the PILOT input measurement point, a bad switch, or that the controller is malfunctioning. The controller is further configured to, if the switched power line is detected at the RELAY input measurement point, indicate an error code that the cooktop has an issue with the RELAY input measurement point, a defective relay, or that the controller is malfunctioning. The controller is further configured to, if no power is detected at the RELAY input measurement point, enter the cooktop lockout mode.

In one or more illustrative examples, the controller is further configured to indicate the entry into the cooktop lockout mode in the HMI.

In one or more illustrative examples, the controller is further configured to, responsive to selection of the lock control while in the cooktop lockout mode, utilize the one or more measurement points to confirm for unlocking that there is no power at the RELAY input measurement point and no power at the PILOT input measurement point; and responsive to the confirmation for unlocking indicating that power is not being supplied, remove the control board relay drive signal to close the first normally closed relay to exit the cooktop lockout mode.

In one or more illustrative examples, the controller is further configured to, responsive to the confirmation for unlocking indicating that power is being supplied at the RELAY input measurement point and that power is being supplied at the PILOT input measurement point, indicate in the HMI that the first switch is ON and the cooktop cannot be unlocked.

In one or more illustrative examples, the controller is further configured to one or more of, responsive to the confirmation for unlocking indicating that power is being supplied at the RELAY input measurement point but no power is being supplied at the PILOT input measurement point, indicate in the HMI that the first switch is ON and the cooktop cannot be unlocked and also raise an error code that the PILOT input measurement point is malfunctioning or the controller encountered an issue while in the cooktop lockout mode; and responsive to the confirmation for unlocking indicating that no power is being supplied at the RELAY input measurement point but power is being supplied at the PILOT input measurement point, indicate in the HMI that the first switch is ON and the cooktop cannot be unlocked and also raise an error code that the RELAY input measurement point is malfunctioning or the controller encountered an issue while in the cooktop lockout mode.

In one or more illustrative examples, the circuit further includes a second switch configured to control power to a second heating element of the cooktop; and a second normally closed relay configured to receive the control board relay drive signal to selectively connect the power line to the second switch, wherein the RELAY input measurement point is connected to the power line between the first normally closed relay and the first switch through a first resistor, and the RELAY input measurement point is further connected to the power line between the second normally closed relay and the second switch through a second resistor.

In one or more illustrative examples, the circuit further includes a hardware lockout comprising a current sensor at the RELAY input measurement point, such that if current over a predefined threshold is detected by the current sensor at the RELAY input measurement point, the cooktop indicates a hardware failure of the first normally closed relay.

In one or more illustrative examples, a circuit for controlling a cooktop lockout feature includes a first switch connected to main power and configured to control the main power to a first heating element of a cooktop; a second switch connected to the main power and configured to control the main power to a second heating element of the cooktop; a first normally closed relay configured to receive a control board relay drive signal to selectively connect a switched power line to the first switch; a second normally closed relay configured to receive the control board relay drive signal to selectively connect the switched power line to the second switch; one or more measurement points configured to measure power along the circuit; a lock control; and a controller. The controller is configured to responsive to selection of the lock control while not in a cooktop lockout mode, utilize the one or more measurement points to confirm that at least the first and second switches are in an OFF position where power is not being supplied to the first and second heating elements, and responsive to confirmation that the power is not being supplied, apply the control board relay drive signal to open the first and second normally closed relays to enter the cooktop lockout mode.

In one or more illustrative examples, the one or more measurement points include a PILOT input measurement point after the first switch and after the second switch connected to a pilot light, and a RELAY input measurement point along the switched power line between the first normally closed relay and the first switch through a first resistor and between the second normally closed relay and the second switch through a second resistor, and the controller is configured to ensure before energizing the relays that there is no power at the PILOT input measurement point to confirm the OFF position of the switches and that there is power at the RELAY input measurement point, responsive to detection of power at the PILOT input measurement point, indicate in an HMI of the cooktop that the cooktop lockout mode cannot be entered because one or more of the switches are ON, and responsive to failure to detect power at the RELAY input measurement point, indicate an error code for the cooktop.

In one or more illustrative examples, the controller is further configured to, after energizing the relays, if the main power is detected at the RELAY input measurement point, indicate an error code that the cooktop has an issue with the PILOT input measurement point, a bad switch, or that the controller is malfunctioning; if the switched power line is detected at the RELAY input measurement point, indicate an error code that the cooktop has an issue with the RELAY input measurement point, a defective relay, or that the controller is malfunctioning; and if no power is detected at the RELAY input measurement point, enter the cooktop lockout mode.

In one or more illustrative examples, the controller is further configured to indicate the entry into the cooktop lockout mode in the HMI of the cooktop.

In one or more illustrative examples, the controller is further configured to, responsive to selection of the lock control while in the cooktop lockout mode, utilize the one or more measurement points to confirm for unlocking that there is no power at the RELAY input measurement point and no power at the PILOT input measurement point; and responsive to the confirmation for unlocking indicating that power is not being supplied, remove the control board relay drive signal to close the relays to exit the cooktop lockout mode.

In one or more illustrative examples, the controller is further configured to, responsive to the confirmation for unlocking indicating that power is being supplied at the RELAY input measurement point and that power is being supplied at the PILOT input measurement point, indicate in the HMI that one or more of the switches are ON and the cooktop cannot be unlocked.

In one or more illustrative examples, the controller is further configured to one or more of, responsive to the confirmation for unlocking indicating that power is being supplied at the RELAY input measurement point but no power is being supplied at the PILOT input measurement point, indicate in the HMI that the first switch is ON and the cooktop cannot be unlocked and also raise an error code that the PILOT input measurement point is malfunctioning or the controller encountered an issue while in the cooktop lockout mode; and responsive to the confirmation for unlocking indicating that no power is being supplied at the RELAY input measurement point but power is being supplied at the PILOT input measurement point, indicate in the HMI that the first switch is ON and the cooktop cannot be unlocked and also raise an error code that the RELAY input measurement point is malfunctioning or the controller encountered an issue while in the cooktop lockout mode.

In one or more illustrative examples, a method for controlling a cooktop lockout feature includes responsive to selection of a lock control of a cooktop while not in a cooktop lockout mode, utilizing one or more measurement points of a cooktop circuit to confirm that at least first and second switches of the cooktop are in an OFF position where power is not being supplied to heating elements of the cooktop, the first and second switches configured to control power to at least first and second heating elements of the cooktop; and responsive to confirmation that the power is not being supplied, applying a control board relay drive signal to open first and second normally closed relays to enter the cooktop lockout mode, the first normally closed relay configured to receive the control board relay drive signal to selectively connect a power line to the first switch, the second normally closed relay configured to receive the control board relay drive signal to selectively connect the power line to the second switch.

In one or more illustrative examples, the one or more measurement points include a PILOT input measurement point after the first switch and after the second switch connected to a pilot light and a RELAY input measurement point along a switched power line between the first normally closed relay and the first switch through a first resistor and between the second normally closed relay and the second switch through a second resistor, and the method further includes ensuring before energizing the relays that there is no power at the PILOT input measurement point to confirm the OFF position of the switches and that there is power at the RELAY input measurement point; responsive to detection of power at the PILOT input measurement point, indicating in an HMI of the cooktop that the cooktop lockout mode cannot be entered because one or more of the switches are ON; and responsive to failure to detect power at the RELAY input measurement point, indicating an error code for the cooktop.

In one or more illustrative examples, the method further includes one or more of, after energizing the relays, if main power is detected at the RELAY input measurement point, indicating an error code that the cooktop has an issue with the PILOT input measurement point, a bad switch, or that the controller is malfunctioning; if relay power is detected at the RELAY input measurement point, indicating an error code that the cooktop has an issue with the RELAY input measurement point, a defective relay, or that the controller is malfunctioning; and if no power is detected at the RELAY input measurement point, entering the cooktop lockout mode.

In one or more illustrative examples, the method further includes, responsive to selection of the lock control while in the cooktop lockout mode, utilizing the one or more measurement points to confirm for unlocking that there is no power at the RELAY input measurement point and no power at the PILOT input measurement point; and responsive to the confirmation for unlocking indicating that power is not being supplied, removing the control board relay drive signal to close the relays to exit the cooktop lockout mode.

### BRIEF DESCRIPTION OF THE DRAWINGS

FIG. 1 illustrates a perspective view of a cooking appliance, in accordance with one or more embodiments of the disclosure;

FIG. 2 illustrates an example portion of a cooktop circuit of the cooktop, in accordance with one or more embodiments of the disclosure;

FIG. 3 illustrates an example schematic diagram of the inputs and outputs of a controller of the cooking appliance of FIGS. 1-2 that is configured to implement a cooktop lockout mode;

FIG. 4 illustrates an example process performed by the controller to implement the control logic of requesting entry into the cooktop lockout mode; and

FIG. 5 illustrates an example process performed by the controller to implement the control logic of requesting an exit from the cooktop lockout mode.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A cooktop may include controls such as rotatable knobs for controlling the power level applied to the heating elements. The cooktop may also include a human-machine interface (HMI) having various buttons and displays. A cooktop lockout mode may be implemented using a button or other control on the HMI, which if selected, locks out use of the knobs. This prevents the cooktop from being activated. The cooktop lockout mode may be implemented using a normally closed (NC) relay, where the NC relay is opened by a control signal in the cooktop lockout mode to prevent cooktop operation. Measurement points may be provided along the power path to ensure the cooktop is in a state where the cooktop lockout may be activated or deactivated. In addition to implementing the lockout, the NC approach is capable of identifying and addressing various other system faults.

Using the NC relay, the customer has access to the cooktop operation at any time even if there is a system issue which can prevent cooktop lockout. This is different from systems that use a normally open (NO) relay, where an issue with the cooktop may completely prevent the consumer from using the cooktop, as the default state of the relays prevents operation of the appliance. Further aspects of the disclosure are discussed in detail herein.

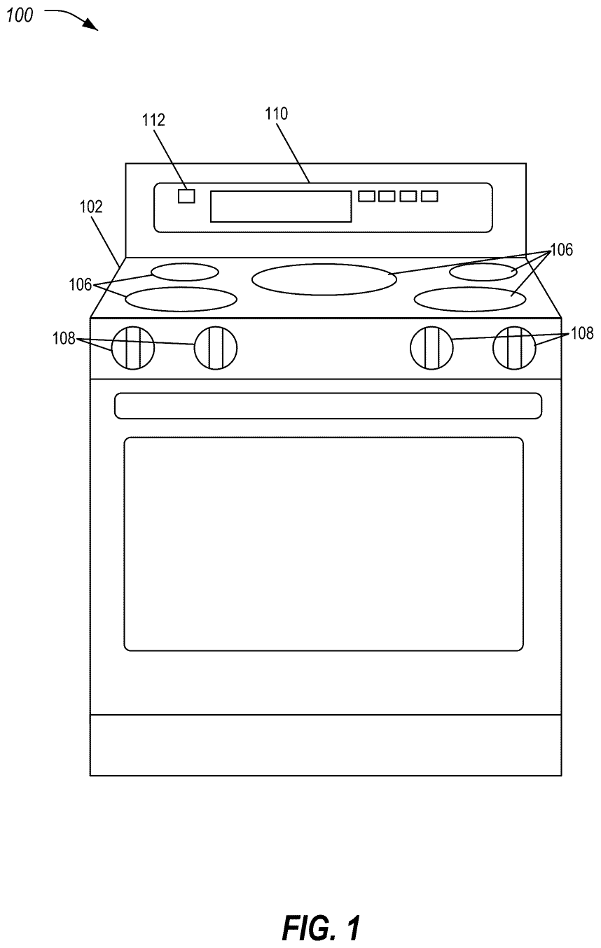

FIG. 1 illustrates a perspective view of a cooking appliance 100. As shown, the cooking appliance 100 is a combination range having both a stove top and an oven in one unit. Ranges may come in a variety of styles, sizes and fuel types, allowing the range to complement different cooking routines and kitchen aesthetics. While a single cavity oven is illustrated, more than one cavity may be included. Or in other examples, the cooking appliance 100 may be a cooktop only, without an oven compartment.

The cooking appliance 100 may define a cooktop surface 102 for receiving cooking utensils. The cooktop surface 102 may be formed of glass, ceramic, or another high-heat resistant surface. Accordingly, the cooking appliance 100 may be configured to heat one or more cooking utensils placed thereon. The cooking utensils may be any type of cooking vessel or other cooking item configured to conduct and withstand high heat, such as a pot, pan, griddle, etc.

One or more heating elements 106 may be arranged on or below the cooktop surface 102. In one non-limiting example, the heating elements 106 may be resistive coils that produce heat for cooking upon application of electrical current from a power source. The cooking utensils placed on the cooktop surface 102 may be heated by the heating elements 106, which, in turn, warms the food contents of the utensils through heat conduction. In some examples, the cooktop surface 102 may be etched or otherwise labeled with indications to notify the user where the heating elements 106 are located on the cooktop surface 102, facilitating correct placement of cooking utensils.

The cooking appliance 100 further include switches 108 for activating and controlling the power applied to the heating elements 106. As shown, these switches 108 take the form of rotary knobs that are rotatable to allow the user to turn on and off the various heating elements 106, as well as to select the power level to apply to the heating elements 106. The illustrated switches 108 are provided at the front of the cooking appliance 100 extending frontwards from the upper front face cooking appliance 100. This is only an example and other configurations are possible, such as switches 108 extending upwards from the front of the cooktop surface 102.

The cooking appliance 100 further includes an HMI 110 for displaying information with respect to the operation of the cooktop (and oven, if applicable) as well as for including additional controls for adjusting the operation of the cooking appliance 100. As shown, the HMI 110 is placed on a backsplash behind the heating elements 106. In other examples, the HMI 110 may be located at the front top of the cooktop surface 102, or even on the front of the cooking appliance 100.

Regardless of location, a lock control 112 may be provided on the HMI 110. The lock control 112 may be used to allow the user to toggle the cooking appliance 100 in and out of a cooktop lockout mode. The cooktop lockout mode is a feature that, when activated, locks the switches 108, preventing the heating elements 106 from being turned on. When selected, and when the switches 108 are in the OFF position, the lock control 112 may be used to enter a lockout menu where the user can either lock the HMI 110, cooktop, or both, thereby preventing operation until the lock control 112 is again pressed (e.g., held for a predefined number of seconds).

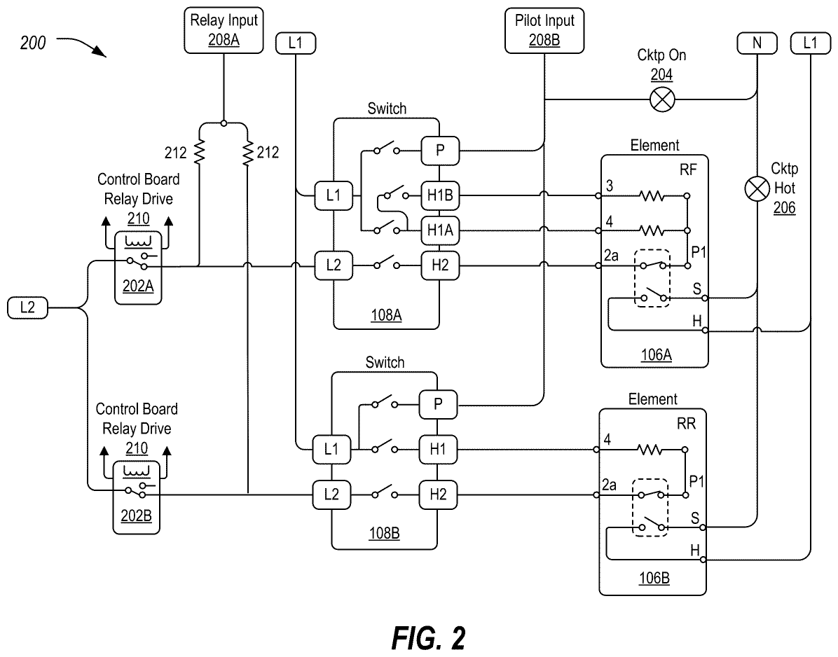

FIG. 2 illustrates an example portion of a cooktop circuit 200 of the cooking appliance 100. The electrical components of the portion of the cooktop circuit 200 include two heating elements 106 which are, for sake of example, a right front dual heating element 106A and a right rear single heating element 106B. The heating element 106A is controlled by a switch 108, which in this example is a dual zone switch 108A, while the heating element 106B is controlled by a single zone switch 108B. Significantly, the cooktop circuit 200 further includes one or more NC relays. As shown, a relay 202A is configured to control the application of power to the dual zone switch 108A, while a relay 202B is configured to control the application of power to the single zone switch 108B. While not shown, additional relays 202 may be included and configured to control the application of power to other switches 108.

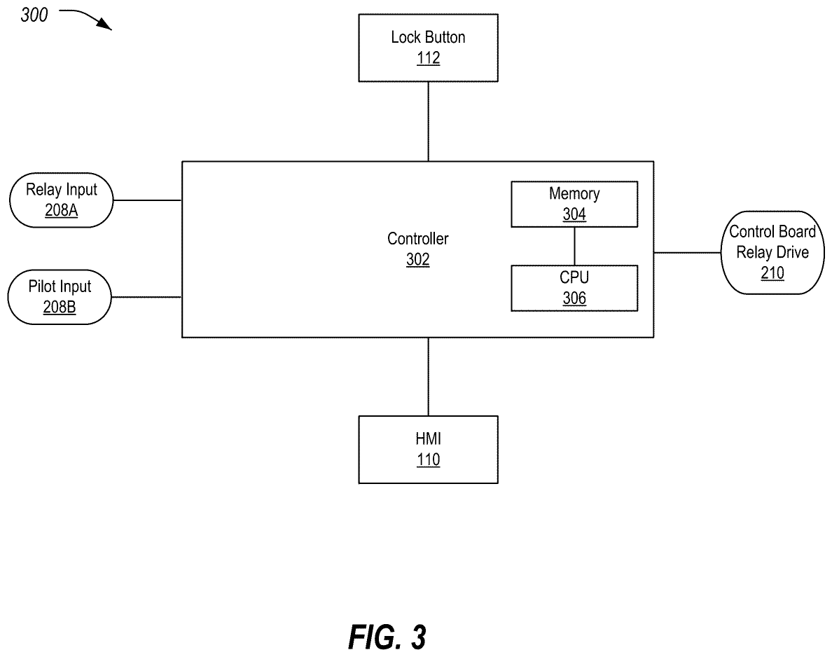

The relay 202A and the relay 202B may be configured to selectively implement the lockout mode under the control of control board relay drive signals 210 (e.g., from a controller 302 as discussed below). For example, if the lock control 112 is pressed, the controller 302 (as shown in FIG. 3) may provide control board relay drive signals 210 to the normally closed relays 202A and 202B, causing the relays 202A, 202B to disconnect both the dual zone switch 108A and the single zone switch 108B from L2. As used herein, the L2 power line refers to the switched power to the cooktop circuit 200 through the relays 202.

The cooktop circuit 200 also includes two indicator lamps: cooktop (Cktp) ON 204 and Cktp Hot 206. It should be noted that while the partial circuit includes two heating elements 106, a full cooktop circuit 200 may include more, fewer, or differently configured heating elements 106, such as left front, left rear, right front, and right rear heating elements 106.

Referring more specifically to the components of the cooktop circuit 200, the dual heating element 106A is a heating element 106 that provides variable heating options with different power levels. As shown, the dual heating element 106A includes two heating elements 106 with power ratings of 1600 W and 1400 W, controlled by internal switches that select the appropriate element based on the inputs received from the dual zone switch 108A. The connections of the dual heating element 106A include terminals for connection to the dual zone switch 108A. As shown, the 1600 W element is connected between Terminal 3 and Terminal 2 a, while the 1400 W element is connected between Terminal 4 and Terminal 2a. The connections of the dual heating element 106A also include a Terminal S which connects internally to both heating element switches for the dual heating elements and externally to the neutral line (N) through the Cktp Hot 206 indicator. Also, Terminal H (hot) connects to the L1 power line. As used herein the L1 power line refers to the main power to the cooktop circuit 200.

As compared to the dual heating element 106A, the single heating element 106B is a heating element 106 that includes a single element. As shown, the single heating element 106B has a power rating of 1200 W, similarly controlled by internal switches based on the inputs received from the single zone switch 108B. The connections of the single heating element 106B include terminals for connection to the single zone switch 108B. Here, the single heating element 106B is connected between Terminal 4 and Terminal 2a. The connections of the single heating element 106B also include a Terminal S which connects internally to the heating element switch and externally to the neutral line (N) again through the Cktp Hot 206 indicator. Also, a Terminal H of the dual heating element 106A connects to the L1 power line.

The dual zone switch 108A is a control switch that selectively directs electrical power from the main power inputs (L1 and L2) to the dual heating element 106A. The dual zone switch 108A has an L1 input which is connected to L1. The dual zone switch 108A also has an L2 input which receives L2 from the normally closed relay 202A (when the normally closed relay 202A is closed). The dual zone switch 108A also has an P input which is connected to neutral (N).

The dual zone switch 108A also has various output terminals which apply power to the inputs of the dual heating element 106A based on the position of the dual zone switch 108A. This allows users to select which heating elements are active and control their power levels, facilitating versatile cooking options. In the illustrated example, the H1A terminal connects to the Terminal 4 of the dual heating element 106A, allowing power to flow to the single 1400 W element if selected. The H1B Terminal connects to Terminal 3 of the dual heating element 106A, allowing power to flow to the dual 1600 W element if selected. The H2 Terminal of the dual zone switch 108A is common to both elements and is connected to Terminal 2a of the dual heating element 106A completing the circuit for both of the dual heating elements.

Similarly, the single zone switch 108B selectively directs electrical power from the main power inputs (L1 and L2) to the single heating element 106B. The single zone switch 108B also has an L1 input which is connected to L1. The single zone switch 108B also has an L2 input which receives L2 from the normally closed relay 202B (when it is closed). The single zone switch 108B also has an P connection which is connected to neutral (N).

The single zone switch 108B also has output terminals which apply power to the inputs of the single heating element 106B based on the position of the single zone switch 108B. The H1 Terminal connects to the Terminal 4 of the single heating element 106B, while the H2 Terminal connects to Terminal 2a of the single heating element 106B completing the circuit.

The Cktp ON 204 indicator lamp is connected between the P terminal of the switches 108A, 108B and neutral. Thus, when activated by either of the switches 108A, 108B (or by any other switches in a multiple heating element 106 design), the Cktp ON 204 is illuminated to indicate that heating elements 106 of the cooktop of the cooking appliance 100 are being powered.

The Cktp Hot 206 indicator lamp is connected between the S terminals of the heating elements 106A, 106B. The S terminal is connected to an internal heat-sensitive switch within the heating elements 106A, 106B (or any other heating element 106 of the design), which closes when the heating elements are hot. This allows the Cktp Hot 206 to be illuminated to indicate the cooktop of the cooking appliance 100 is hot whether or not it is presently being powered.

The relay 202A receives power from L2 and, based on the control board relay drive signals 210, selectively applies that power to the L2 input of the dual zone switch 108A. The relay 202B also receives power from the L2 input and, based on the same control board relay drive signals 210, selectively applies power to the L2 input of single zone switch 108B. These relays 202A, 202B are normally closed electromechanical switches that use an electrical signal to open or close their contacts, managing the flow of electricity based on the control board relay drive signals 210. A similar arrangement may be provided for any additional heating elements 106, switches 108, and relays 202.

Measurement points 208A, 208B are also provided in the cooktop circuit 200. These include the RELAY input measurement point 208A and the PILOT input measurement point 208B. The RELAY input measurement point 208A is connected to the switch 108 side of the relay-controlled L2 lines (e.g., between the L2 output of the relay 202A and the L2 input of the dual zone switch 108A and between the L2 output of the relay 202B and the L2 input of the single zone switch 108B). The PILOT input measurement point 208B is provided on the P outputs of each of the switches 108A, 208, on the same line as the Cktp ON 204 indicator.

For protection, resistors 212 (e.g., 57 k resistors in an example), may be provided between the RELAY input measurement point 208A and each of the L2 lines. For example, a first resistor 212A is electrically connected between the output of the relay 202A and the RELAY input measurement point 208A, and a second resistor 212B is electrically connected between the output of the relay 202B and the RELAY input measurement point 208A.

FIG. 3 illustrates an example schematic diagram 300 of the inputs and outputs of a controller 302 configured to implement the cooktop lockout mode. The controller 302 may be provided with a memory 304 and a central processing unit (CPU) 306. The memory 304 may be used for storing the control logic that may be executed by the CPU 306 for performing functions of the cooking appliance 100 discussed in detail herein. A memory 144 may also be used to store information, such as lookup tables, timing information, etc., as well as to store data received from the one or more components of the cooking appliance 100 that may be communicably coupled with the controller 302.

As shown, the controller 302 is configured to receive input from the measurement points 208A, 208B. Additionally, the controller 302 is connected to the lock control 112 to receive user input for selection of the lockout mode. Based on the inputs, the controller 302 executed the software stored to the memory 304 to provide the control board relay drive signals 210 for controlling the signaling of the relay(s) 202. Additionally, the controller 302 provides output to the HMI 110 to display messages related to the operational status of the cooking appliance 100 in relation to the cooktop lockout mode.

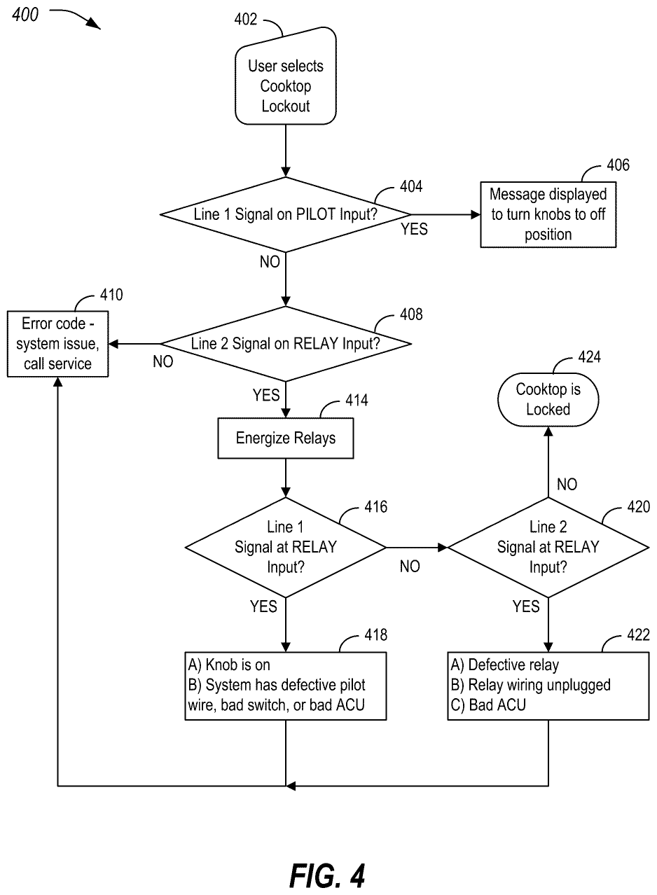

FIG. 4 illustrates an example process 400 performed by the controller 302 to implement the control logic of requesting entry into the cooktop lockout mode. In an example, the controller 302 may operate in the context of the hardware and signaling shown in FIGS. 1-3. It should be noted that the process 400 may be time-sensitive. For instance, in some implementations the operations in the dotted area may be allocated a maximum timing budget for their performance (e.g., within one second).

At operation 402, the controller 302 receives an indication that the lock control 112 is pressed. When the user wants to activate the cooktop lockout mode, the user presses the lock control 112 on the HMI 110. Responsive to the press, the controller 302 executes the remainder of the process 400, which performs a series of checks to identify any of various faults. If any of the faults are realized, the controller 302 may provide an error message to the HMI 110 to notify the user the lockout feature is unavailable and/or raise one or more error codes based on the identified faults.

More specifically, at operation 404, the controller 302 measures the voltage at the PILOT input measurement point 208B. This may be done to ensure that the switches 108 are in the HOME or OFF position. If the L1 signal is detected at the PILOT input measurement point 208B, then the controller 302 identifies that one or more of the switches 108 is set to an ON position. If this occurs, control proceeds to operation 406 to inform the user that the cooktop lockout mode cannot be engaged. If, however, L1 is not detected at the PILOT input measurement point 208B, control proceeds to operation 408.

At operation 406, the controller 302 sets the HMI 110 to display a message indicating that the switches 108 need to be turned OFF before the cooktop lockout mode may be entered. After operation 406, the process 400 ends. The process 400 may restart if the user again attempts to select the cooktop lockout.

Next, at operation 408, the controller 302 measures the signal at the RELAY input measurement point 208A. If the cooktop circuit 200 is operating correctly, the relays 202 will be closed and signal will be detected from L2. If no signal is detected, then control passes to operation 410 to indicate an error condition. At operation 410, an error code is used, for example, to indicate a system issue with the appliance and/or to call service.

If signal is detected at the RELAY input measurement point 208A, control proceeds to operation 414 to energize the relays 202. Energizing the relays 202 may be performed by applying the control board relay drive signal 210 to the relays 202. As the relays 202 are normally closed, energizing the relays 202 should open the circuit between L2 and the RELAY input measurement point 208A. Once the relays 202 are opened, the controller 302 again measures the signal at the RELAY input measurement point 208A.

At operation 416, the controller 302 determines whether the L1 signal is detected at the RELAY input measurement point 208A. If so, as shown at 418 this may indicate A) one of the switches 108 is turned and/or B) the cooking appliance 100 has a defective pilot wire, a bad switch 108, or a bad controller 302. After operation 416, control returns to operation 410 to raise the error.

If L1 signal is not detected at the RELAY input measurement point 208A, control proceeds to operation 420, where the controller 302 determines whether the L2 signal is detected at the RELAY input measurement point 208A. If so, as shown at 420 this may indicate A) a defective relay 202 (e.g., that did not open), B) that relay 202 wiring is unplugged, and/or C) the cooking appliance 100 has a bad controller 302. After operation 422, control returns to operation 410 to raise the error.

If no signal is detected by the RELAY input measurement point 208A, at operation 424 the controller 302 enters the cooktop lockout mode. In the cooktop lockout mode, the switches 108 are disabled such that the cooktop of the cooking appliance 100 cannot be turned on.

In another aspect, an additional potential fault may be detected in hardware, without the use of the controller 302. For example, the cooking appliance 100 may determine whether there is an overcurrent at RELAY input measurement point 208A. For instance, the cooking appliance 100 may measure the current flow at the RELAY input measurement point 208A at a hardware level. If the current at the RELAY input measurement point 208A is at a high level (e.g., >20 Amps), then this may indicate that one of the relays 202 is failed in the open position or is not properly plugged in. This mode may not be detectable in software by the controller 302.

As one example situation, if relay 202B fails, the two cooktop sides may be connected via the RELAY input measurement point 208A which may cause all the current to flow through the relay 202A. In this situation, the resistors 212A, 212B may serve to mitigate overcurrent of the relay 202A. A similar condition may occur upon failure of the relay 202A with respect to overcurrent of the relay 202B. If such a condition is detected by the current at RELAY input measurement point 208A, this may also raise an error code, similar to as discussed at operation 410.

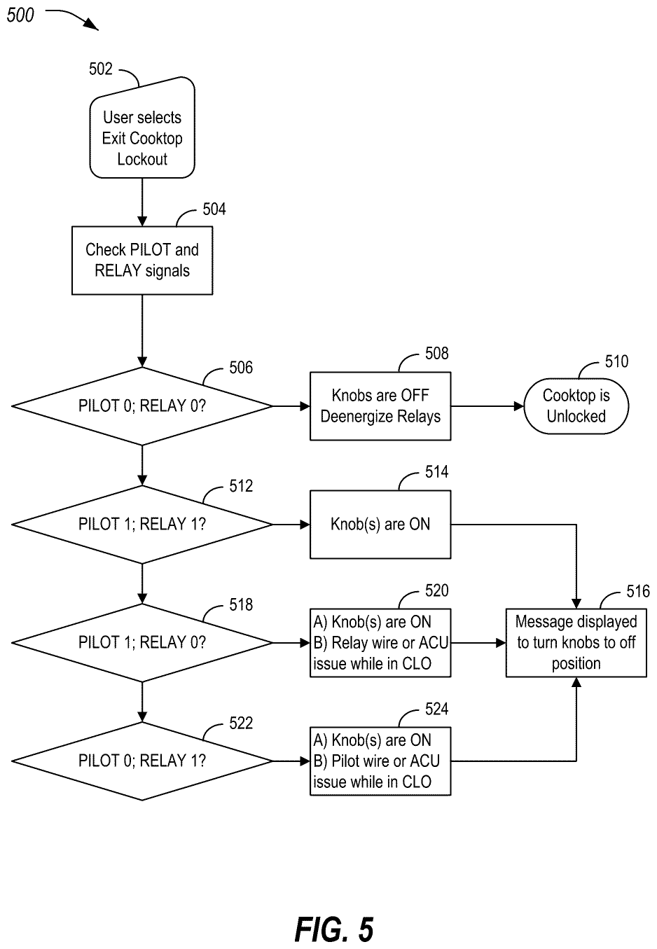

FIG. 5 illustrates an example process 500 performed by the controller 302 to implement the control logic of requesting an exit from the cooktop lockout mode. In an example, as with the process 400, the controller 302 may operate in the context of the hardware and signaling shown in FIGS. 1-3.

At operation 502, the controller 302 receives an indication that the lock control 112 is pressed. When a user wants to deactivate the cooktop lockout mode, the user again presses the lock control 112 on the HMI 110. Responsive to the press, the controller 302 executes the remainder of the process 500, which performs a series of checks to identify whether the cooktop lockout mode may be exited. If any of the checks do not pass, the controller 302 provides an error message to the HMI 110 to notify the user that the lockout mode cannot be exited.

At operation 504, the controller 302 measures for signal at the RELAY input measurement point 208A and at the PILOT input measurement point 208B. These measurements are then checked in the remaining operations of the process 500.

At operation 506, if no power is detected at the RELAY input measurement point 208A and no power is detected at the PILOT input measurement point 208B, then the controller 302 determines at 508 that all of the switches 108 are OFF. Here, control passes to operation 510. At operation 510, the controller 302 deactivated the cooktop lockout mode. In some examples, the controller 302 displays a message to the HMI 110 indicating that the cooktop lockout mode is deactivated. After operation 510, the process 500 ends.

Otherwise, continuing to operation 512 from operation 506, if the controller 302 detects power at both the RELAY input measurement point 208A and at the PILOT input measurement point 208B, then, as indicated at 514, the controller 302 infers that one or more of the switches 108 are ON. Thus, at operation 516, the controller 302 displays a message to the HMI 110 indicating that the user must turn off all of the switches 108 before deactivating the cooktop lockout mode. After operation 516, control returns to receive user input at operation 502.

Otherwise, continuing to operation 518 from operation 512, if the controller 302 detects power at the PILOT input measurement point 208B but not at the RELAY input measurement point 208A, then as indicated at 520 this may mean A) one or more switches 108 are ON, as well as B) an issue occurred with a relay wire connecting to or from one of the relays 202 or the controller 302 while locked. Regardless, control proceeds to operation 516 to request the user to turn the switches 108 all to OFF and retry.

Finally, continuing to operation 522 from operation 518, if the controller 302 detects power at the RELAY input measurement point 208A but not at the PILOT input measurement point 208B, then, as indicated at 524, this may mean A) one or more switches 108 are ON, as well as B) a pilot wire or controller 302 issue occurred while locked. Regardless, control proceeds to operation 516 to request the user to turn the switches 108 all to OFF and retry.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A circuit for controlling a cooktop lockout feature, comprising:
a first switch connected to main power and configured to control the main power to a first heating element of a cooktop;
a first normally closed relay configured to receive a control board relay drive signal to selectively connect a switched power line to the first switch;
one or more measurement points configured to measure power along the circuit;
a lock control; and
a controller configured to:
responsive to selection of the lock control while not in a cooktop lockout mode, utilize the one or more measurement points to confirm that at least the first switch is in an OFF position where power is not being supplied to the first heating element, and
responsive to confirmation that the power is not being supplied, apply the control board relay drive signal to open the first normally closed relay to enter the cooktop lockout mode.

2. The circuit of claim 1, wherein the one or more measurement points include:
a PILOT input measurement point after the first switch connected to a pilot light, and
a RELAY input measurement point along the switched power line between the first normally closed relay and the first switch, and
the controller is configured to:
ensure before energizing the first normally closed relay that there is no power at the PILOT input measurement point to confirm the OFF position of the first switch and that there is power at the RELAY input measurement point,
responsive to detection of power at the PILOT input measurement point, indicate in a human-machine interface (HMI) of the cooktop that the cooktop lockout mode cannot be entered because the first switch is ON, and
responsive to failure to detect power at the RELAY input measurement point, indicate an error code for the cooktop.

3. The circuit of claim 2, wherein the controller is further configured to, after energizing the first normally closed relay:
if the main power is detected at the RELAY input measurement point, indicate an error code that the cooktop has an issue with the PILOT input measurement point, a bad switch, or that the controller is malfunctioning,
if the switched power line is detected at the RELAY input measurement point, indicate an error code that the cooktop has an issue with the RELAY input measurement point, a defective relay, or that the controller is malfunctioning, and
if no power is detected at the RELAY input measurement point, enter the cooktop lockout mode.

4. The circuit of claim 3, wherein the controller is further configured to indicate the entry into the cooktop lockout mode in the HMI.

5. The circuit of claim 2, wherein the controller is further configured to:
responsive to selection of the lock control while in the cooktop lockout mode, utilize the one or more measurement points to confirm for unlocking that there is no power at the RELAY input measurement point and no power at the PILOT input measurement point; and
responsive to the confirmation for unlocking indicating that power is not being supplied, remove the control board relay drive signal to close the first normally closed relay to exit the cooktop lockout mode.

6. The circuit of claim 5, wherein the controller is further configured to:
responsive to the confirmation for unlocking indicating that power is being supplied at the RELAY input measurement point and that power is being supplied at the PILOT input measurement point, indicate in the HMI that the first switch is ON and the cooktop cannot be unlocked.

7. The circuit of claim 5, wherein the controller is further configured to one or more of:
responsive to the confirmation for unlocking indicating that power is being supplied at the RELAY input measurement point but no power is being supplied at the PILOT input measurement point, indicate in the HMI that the first switch is ON and the cooktop cannot be unlocked and also raise an error code that the PILOT input measurement point is malfunctioning or the controller encountered an issue while in the cooktop lockout mode, and
responsive to the confirmation for unlocking indicating that no power is being supplied at the RELAY input measurement point but power is being supplied at the PILOT input measurement point, indicate in the HMI that the first switch is ON and the cooktop cannot be unlocked and also raise an error code that the RELAY input measurement point is malfunctioning or the controller encountered an issue while in the cooktop lockout mode.

8. The circuit of claim 2, further comprising:
a second switch configured to control power to a second heating element of the cooktop; and
a second normally closed relay configured to receive the control board relay drive signal to selectively connect the power line to the second switch,
wherein:
the RELAY input measurement point is connected to the power line between the first normally closed relay and the first switch through a first resistor, and
the RELAY input measurement point is further connected to the power line between the second normally closed relay and the second switch through a second resistor.

9. The circuit of claim 2, wherein the circuit further includes a hardware lockout comprising a current sensor at the RELAY input measurement point, such that if current over a predefined threshold is detected by the current sensor at the RELAY input measurement point, the cooktop indicates a hardware failure of the first normally closed relay.

10. A circuit for controlling a cooktop lockout feature, comprising:
a first switch connected to main power and configured to control the main power to a first heating element of a cooktop;
a second switch connected to the main power and configured to control the main power to a second heating element of the cooktop;
a first normally closed relay configured to receive a control board relay drive signal to selectively connect a switched power line to the first switch;
a second normally closed relay configured to receive the control board relay drive signal to selectively connect the switched power line to the second switch;
one or more measurement points configured to measure power along the circuit;
a lock control; and
a controller configured to:
responsive to selection of the lock control while not in a cooktop lockout mode, utilize the one or more measurement points to confirm that at least the first and second switches are in an OFF position where power is not being supplied to the first and second heating elements, and
responsive to confirmation that the power is not being supplied, apply the control board relay drive signal to open the first and second normally closed relays to enter the cooktop lockout mode.

11. The circuit of claim 10, wherein the one or more measurement points include:
a PILOT input measurement point after the first switch and after the second switch connected to a pilot light, and
a RELAY input measurement point along the switched power line between the first normally closed relay and the first switch through a first resistor and between the second normally closed relay and the second switch through a second resistor, and
the controller is configured to:
ensure before energizing the relays that there is no power at the PILOT input measurement point to confirm the OFF position of the switches and that there is power at the RELAY input measurement point,
responsive to detection of power at the PILOT input measurement point, indicate in an HMI of the cooktop that the cooktop lockout mode cannot be entered because one or more of the switches are ON, and
responsive to failure to detect power at the RELAY input measurement point, indicate an error code for the cooktop.

12. The circuit of claim 11, wherein the controller is further configured to, after energizing the relays:
if the main power is detected at the RELAY input measurement point, indicate an error code that the cooktop has an issue with the PILOT input measurement point, a bad switch, or that the controller is malfunctioning;
if the switched power line is detected at the RELAY input measurement point, indicate an error code that the cooktop has an issue with the RELAY input measurement point, a defective relay, or that the controller is malfunctioning; and
if no power is detected at the RELAY input measurement point, enter the cooktop lockout mode.

13. The circuit of claim 12, wherein the controller is further configured to indicate the entry into the cooktop lockout mode in the HMI of the cooktop.

14. The circuit of claim 11, wherein the controller is further configured to:
responsive to selection of the lock control while in the cooktop lockout mode, utilize the one or more measurement points to confirm for unlocking that there is no power at the RELAY input measurement point and no power at the PILOT input measurement point; and
responsive to the confirmation for unlocking indicating that power is not being supplied, remove the control board relay drive signal to close the relays to exit the cooktop lockout mode.

15. The circuit of claim 14, wherein the controller is further configured to:
responsive to the confirmation for unlocking indicating that power is being supplied at the RELAY input measurement point and that power is being supplied at the PILOT input measurement point, indicate in the HMI that one or more of the switches are ON and the cooktop cannot be unlocked.

16. The circuit of claim 14, wherein the controller is further configured to one or more of:
responsive to the confirmation for unlocking indicating that power is being supplied at the RELAY input measurement point but no power is being supplied at the PILOT input measurement point, indicate in the HMI that the first switch is ON and the cooktop cannot be unlocked and also raise an error code that the PILOT input measurement point is malfunctioning or the controller encountered an issue while in the cooktop lockout mode; and
responsive to the confirmation for unlocking indicating that no power is being supplied at the RELAY input measurement point but power is being supplied at the PILOT input measurement point, indicate in the HMI that the first switch is ON and the cooktop cannot be unlocked and also raise an error code that the RELAY input measurement point is malfunctioning or the controller encountered an issue while in the cooktop lockout mode.

17. A method for controlling a cooktop lockout feature, comprising:
responsive to selection of a lock control of a cooktop while not in a cooktop lockout mode, utilizing one or more measurement points of a cooktop circuit to confirm that at least first and second switches of the cooktop are in an OFF position where power is not being supplied to heating elements of the cooktop, the first and second switches configured to control power to at least first and second heating elements of the cooktop; and
responsive to confirmation that the power is not being supplied, applying a control board relay drive signal to open first and second normally closed relays to enter the cooktop lockout mode, the first normally closed relay configured to receive the control board relay drive signal to selectively connect a power line to the first switch, the second normally closed relay configured to receive the control board relay drive signal to selectively connect the power line to the second switch.

18. The method of claim 17, wherein the one or more measurement points include a PILOT input measurement point after the first switch and after the second switch connected to a pilot light and a RELAY input measurement point along a switched power line between the first normally closed relay and the first switch through a first resistor and between the second normally closed relay and the second switch through a second resistor, and further comprising:
ensuring before energizing the relays that there is no power at the PILOT input measurement point to confirm the OFF position of the switches and that there is power at the RELAY input measurement point;
responsive to detection of power at the PILOT input measurement point, indicating in an HMI of the cooktop that the cooktop lockout mode cannot be entered because one or more of the switches are ON; and
responsive to failure to detect power at the RELAY input measurement point, indicating an error code for the cooktop.

19. The method of claim 18, further comprising one or more of after energizing the relays:
if main power is detected at the RELAY input measurement point, indicating an error code that the cooktop has an issue with the PILOT input measurement point, a bad switch, or that the controller is malfunctioning;
if relay power is detected at the RELAY input measurement point, indicating an error code that the cooktop has an issue with the RELAY input measurement point, a defective relay, or that the controller is malfunctioning; and
if no power is detected at the RELAY input measurement point, entering the cooktop lockout mode.

20. The method of claim 18, further comprising:
responsive to selection of the lock control while in the cooktop lockout mode, utilizing the one or more measurement points to confirm for unlocking that there is no power at the RELAY input measurement point and no power at the PILOT input measurement point; and
responsive to the confirmation for unlocking indicating that power is not being supplied, removing the control board relay drive signal to close the relays to exit the cooktop lockout mode.
